(19) United States
(12) Patent Application Publication
(10) Pub. No.: US 2011/0009001 A1
(43) Pub. Date: Jan. 13, 2011

(54) UNIVERSAL SERIAL BUS CONNECTOR

(75) Inventors: Chih-Cheng CHEN, Taoyuan Hsien (TW); Hua-Chun CHANG, Taoyuan Hsien (TW)

Correspondence Address: BRIAN M. MCINNIS, 12th Floor, Ruttonjee House, 11 Duddell Street, Hong Kong, HK

(73) Assignee: SPEED TECH CORP., TAOYUAN HSIEN (TW)

(21) Appl. No.: 12/779,887

(22) Filed: May 13, 2010

(30) Foreign Application Priority Data
Jul. 13, 2009 (TW) 98212766

(51) Int. Cl. H01R 13/648

(52) U.S. Cl. 439/607.01

(57) ABSTRACT

An improved Universal Serial Bus (USB) connector mounted on a print circuit board for transmitting electric signals between a dock connector and the print circuit board. The improved Universal Serial Bus connector comprises a set of first terminals, a set of second terminals, an insulator, and a shielding shell. Each of the first terminals and the second terminals is respectively fixed on the insulator. The insulator includes a cap, on which each of the first terminals and the second terminals is disposed, and is substantially enclosed by the shielding shell.

### RELATED APPLICATIONS

This application claims priority to Taiwan application no. 98212766, filed Jul. 13, 2009, the entirety of which is incorporated herein by reference.

### BACKGROUND

1. Field of Invention

The disclosure is relevant to an improved Universal Serial Bus (USB) connector, and, particularly, the device having a further set of terminals within a conventional Universal Serial Bus connector for improving the electric signal transmitting speed.

2. Description of Related Art

Universal Serial Bus, which is the most popular transmitting interface in the electronics' market, mainly includes a cable end connector and a board end connector matching to each other for communicating electrical signals between the cable and the print circuit board. Currently, some memory chip are disposed within the cable end Universal Serial Bus connector such that the cable end Universal Serial Bus connector may match with the board end connector without carrying any cable, and the memory chip embedded in the cable end connector can communicate the electric signals through the print circuit board of the board end connector.

The current USB 2.0 interface standard mainly establishes two transmitting rate including a High Speed “480 Mb/s” with high bandwidth and a Full Speed “12 Mb/s” with low bandwidth. The Full Speed with low bandwidth is provided for the mouse and keyboard, which in general, do not be used to transmit large quantity of data within a short period of time.

Although USB 2.0 interface is very popular in the electronic products, however, as the quantity of the data transmitted between the electrical devices increases, the transmitting speed of USB 2.0 has to be raised up to shorten the time consumption for transmitting the large amount of data. The USB 3.0 interface published on Nov. 12, 2008 establishes a Super Speed transmitting rate, which can reach the speed “5.0 Gb/s.” Because the transmitting rate of USB 3.0 interface standard increases, two more pairs of differential terminals and a ground terminal are needed.

FIG. 13 shows a right-angle USB 3.0 board end connector disclosed by is Taiwan utility model patent No. M348358, which occupies the least area on the print circuit board but do not reduce the height of the connector on the print circuit board.

The conventional connector, as shown in the FIG. 13, consists of a plurality of first terminals A, a plurality of second terminals B, a first body C, a second body D, and a shielding shell E. Each of the first terminals A and the second terminals B respectively includes a contact portion (A1, B1), a tail portion (A2, B2) and an extended portion (A3, B3). The contact portion (A1, B1) of each of the terminals (A, B) can be respectively electrically connected to a complement cable end connector. The tail portion (A2, B2) of each of the terminals (A, B) is respectively electrically connected to a circuit board (not shown) to form the electric connection. The extended portion (A3, B3) of each of the terminals (A, B) is respectively connected to the contact portion (A1, B1) and the tail portion (A2, B2) of each of the terminals. In the first body C, the insert molding scheme is used to embed a part of each of the first terminals A into the plastic insulator. A tongue portion C1 is formed on one end of the first body C, and the contact portion A1 of each of the first terminals A is exposed out of the tongue portion C1 of the first body C. In the second body D, the insert molding scheme is also applied to embed a part of each of the second terminals B into the plastic insulator, and the contact portion B1 of each of the to second terminals B is exposed out of the second body D. There are adequate holding mechanism on the first body C and the second body D for assembling the two bodies, and a shielding shell E substantially encloses the first body C and the second body D.

In the USB 3.0 board end connector of FIG. 13, the first terminal A is includes two pairs of terminals for transmitting differential electric signals and a terminal for grounding. The electronic signals transmitted by the second terminal B are substantially consistent with well-known USB 2.0 terminals, and the contact portion (A1, B1) of each of the terminals A and the terminals B is disposed on the same surface of the tongue portion C1. And, the contact portion A1 of the first terminal A is disposed relative closer to the edge of the tongue portion C1 than that of the contact portion B1 of the second terminal B.

Before completely assembling the first body C and the second body D to the conventional Universal Serial Bus connectors, the contact portions B1 of each of the second contact terminal B are not protected and fully exposed, hence they are easy to be damaged during transportation and further assembly. Furthermore, the first body C, and the second body D is respectively molded outside each of the first terminals A and the second terminals B by use of the inserting molding manufacturing process, and thus the cost and life of the mold of the first body C and the second body D are incomparable to the traditional assembling manufacturing process. However, the traditional manufacturing process cannot efficiently assembly the contact portions of the terminals A, B on different positions of the same surface of the tongue portion C1, simultaneously.

In view of the problems recited above, there exists a need of an improved conventional Universal Serial Bus board-side connector.

### SUMMARY

The first object of the disclosure is to provide an improved Universal Serial Bus connector, and, particularly, an improved Universal Serial Bus connector that disposes the terminals within an insulator without using the insert molding manufacturing process.

The second object of this disclosure is to provide an improved Universal Serial Bus connector, and, particularly, an improved Universal Serial Bus connector that provides suitable protection for the contact portions of the connector.

The improved Universal Serial Bus connector includes a set of first terminals, a set of second terminals and an insulator. Each of the first terminals and the second terminals respectively includes a contact portion, a tail portion, and an extended portion, and each of the first terminals and the second terminals is respectively assembled onto the insulator. At least one cap removably disposed on the insulator. The extended portion of each of the first terminals and the second terminals is respectively disposed at a different position of the cap. The predetermined contact portion of the first terminal for conducting with the dock device, or complement cable end connector, is protruding from the terminal receiving grooves of the insulator. And, each of the first terminals and the second terminals is fixed on the insulator by the cap.

Since each of the first terminals and the second terminals of the Universal Serial Bus connector is disposed on the cap of the insulator, and the cap is disposed on the insulator during assembling fabrication, therefore, the Universal Serial Bus connector can be made without using the insert molding to manufacturing process, which molds each of the first terminals and the second terminals into the insulator. Furthermore, the technique of the disclosure can also be applied to the Universal Serial Bus Connectors stacked on the circuit board while the terminals of the respective Universal Serial Bus connectors can be disposed in the insulator in turn such that the stacked Universal Serial Bus is connectors can be easily disposed on the insulator by the caps.

To the convenience of assembly, disposing each of the first terminals and the second terminals in the cap, the terminal receiving grooves can be made on the opposite upper and lower surfaces of the cap. Since each of the first terminals and the second terminals is respectively disposed on the cap, and the cap is disposed on the insulator, the extended portion of each of the first terminals and the second terminals can be kept within the insulator. The insulator can be used for protecting the extended portion of each of the first terminals and the second terminals to prevent the extended portion of each of the first terminals and the second terminals from exposing to the environment outside of the insulator.

### BRIEF DESCRIPTION OF THE DRAWINGS

FIG. 1 shows the perspective view of the first embodiment of the disclosure;

FIG. 2 shows the perspective view of the first embodiment of the disclosure from another viewpoint;

FIG. 3 shows the perspective, explosive view of the first embodiment of the disclosure;

FIG. 4 shows the perspective, explosive view of the first to embodiment of the disclosure from another viewpoint;

FIG. 5 is the top view of FIG. 1 of the disclosure;

FIG. 5a is the sectional view along Line A-A in FIG. 5 of the disclosure;

FIG. 5b is the sectional view along Line B-B in FIG. 5 of the is disclosure;

FIG. 6 shows the perspective view of the second embodiment of the disclosure;

FIG. 7 shows the perspective view of the second embodiment of the disclosure from another viewpoint;

FIG. 8 shows the perspective view of the second embodiment of the disclosure;

FIG. 9 shows the perspective view of the second embodiment of the disclosure from another viewpoint;

FIG. 10 shows the explosive view of a portion of the second embodiment of the disclosure;

FIG. 11 is the top view of FIG. 10 of the disclosure;

FIG. 11a is the sectional view along Line C-C of FIG. 11 of the disclosure;

FIG. 12 is the top view of FIG. 6 of the disclosure;

FIG. 12a is the sectional view along Line D-D of FIG. 12 of the disclosure;

FIG. 12b is the sectional view along Line E-E of FIG. 12 of the disclosure; and

FIG. 13 is the schematic illustrating the prior art.

### DESCRIPTION OF THE PREFERRED EMBODIMENTS

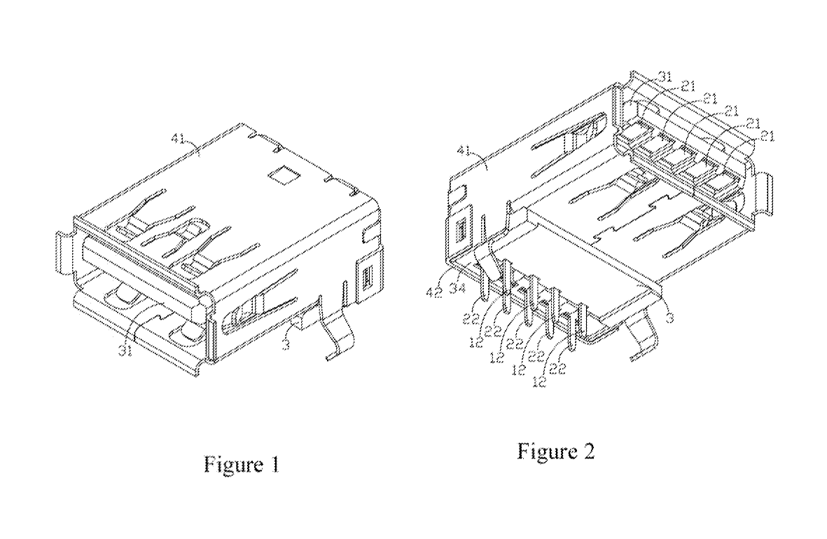

FIGS. 1 to 4 depict the Universal Serial Bus connector according to the first embodiment of the disclosure, i.e., a board end USB 3.0 connector, adapted to be disposed on a print circuit board (not shown) and to communicate the electric signals between a dock connector and the circuit board.

In the first embodiment of the disclosure, the Universal Serial Bus connector comprises a set of first terminals 1, a set of the second terminal 2, an insulator 3 and a shielding shell 4. The contact portion (11, 21) of each of the first terminal 1 and the second terminal 2 can be respectively connected to the dock connector or a cable end connector (not show). The tail portion (12, 22) of each of the first terminal 1 and the second terminal 2 can be respectively connected to a circuit board (not shown) to form the electric connection. The extended portion (13, 23) of each of the first terminals 1 and the second terminals 2 is connected to the contact portion (11, 21) and the tail portion (12, 22) of each of the first terminal 1 and the second terminal 2. Further, the extended portion of each of the first terminal 1 and the second terminal 2 respectively has a protrusion or protrusions (131, 231).

The insulator 3 is made of an insulating material. A tongue portion 31 extends to the dock connector (not shown) from the insulator 3, which has a notch 32 remote from the tongue portion 31. The insulator further comprises a cap 33 having a plurality of first terminal receiving grooves 331, and a plurality of second terminal receiving grooves 332, and the cap 33 can be fixed into the notch 32 of the insulator 3. The size of the first terminal receiving groove 331 of the cap 33 is adapted to accommodate the first terminal 1, and the protrusion 131 of the extended portion 13 of the first terminal is dimensioned a bit larger than the first terminal receiving groove 331 such that the protrusion 131 of the extended portion 13 of the first terminal 1 interferences with the first terminal receiving groove 331 of the cap 33 in order to fix the extended portion 13 of the first terminal 1 within the first terminal receiving groove 331 of the cap 33 when the extended portion 13 of the first terminal 1 is assembled into the first terminal receiving groove 331 of the cap 33. Similarly, the interference between the protrusion 231 of the extended portion of the second terminal 2 and the second terminal receiving groove 332 of the cap 33 is used to keep the extended portion 23 of the second terminal 2 within the second terminal receiving groove 332 of the cap 3.

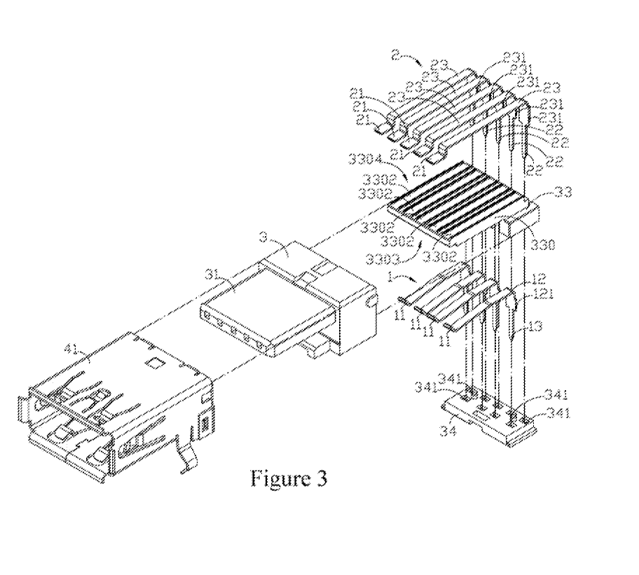

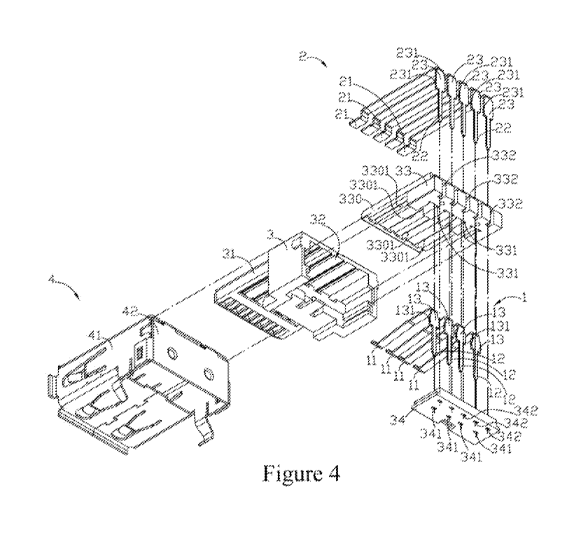

FIGS. 3 and 4 illustrate the first embodiment of the disclosure, wherein the first terminal receiving grooves 331 and the second terminal receiving grooves 332 are disposed on separate surfaces, opposite surfaces in the drawings, and thus the first terminal 1 and the second terminal 2 can be assembled into the terminal receiving grooves 331, 332 of the cap 33 simultaneously by production labor from different directions so that the first terminal 1 and the second terminal 2 are disposed on separate surfaces of the cap 33. The first embodiment of the disclosure is an example for implementing the disclosure, and the first terminal 1 and the second terminal 2 could be fixed into the terminal receiving grooves 331, 332 of the cap 33 in the same direction asynchronously according to the demand if there is a need.

Please refer to FIGS. 3 and 4, since the distance from the contact portion (11, 21) to the protrusion (131, 231) is substantially long, it is required to that a rim 330 extend from the cap 33 along the direction of the tongue portion 31 of the insulator 3, so as to prevent the contact portions (11, 21) of the first terminal 1 and the second terminal 2 from contacting each other accidentally. The rim 330 has extended grooves (3301, 3302) so as to match the terminal receiving grooves (331, 332) of the cap 33. Each of the extended grooves (3301, 3302) is separated by partition wall (3303, 3304) so as to prevent the contact portions (11, 21) of the first terminal 1 and the second terminal 2 from resulting a short cut.

Please refer to FIGS. 3 and 4, since the distance from the contact portions (11, 21) to the protrusions (131, 231) is substantially long, and the true positions for the tail portions (12, 22) of the terminals (1, 2) are required, to achieve the true positions of the tail portions (12, 22) of the terminals of the Universal Serial Bus connector, the first embodiment of the disclosure provides an alternative design of a spacer 34 for the tail portions (12, 22) of the terminals, wherein the spacer 34 can be disposed on the insulator 3 and thereby becomes a part of the insulator 3. The spacer 34 is capable to be disposed within the notch 32 of the insulator 3, and the spacer 34 may be disposed between the cap 33 and the circuit board (not shown). The spacer 34 has a plurality of perforating channels 341, which can be penetrated by the tail portions (12, 22) of the terminals (1, 2), to electrically isolate each tail portion (12, 22) of the terminals (1, 2).

In the first embodiment of the disclosure, the insulator 3 is held by a shielding shell 4, which is made of a thin metal sheet and comprises a body 41 and a rear cover 42. The body 41 of the shielding shell 4 substantially encloses the insulator 3, and the rear cover 41 of the shielding shell 4 is to cover the notch 32 of the insulator 3. Please note that the rear cover of the in shielding shells in FIGS. 3 and 4 are depicted as in a covered status. The shielding shell 4 can shield the effects of the electro-magnetic wave of the environment from the Universal Serial Bus connector, and enhance the mechanic strength of the entire Universal Serial Bus connector.

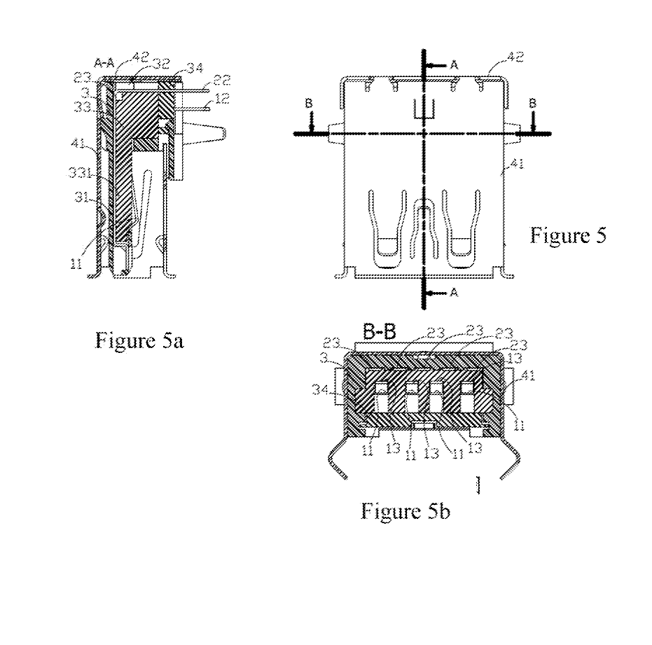

FIGS. 5, 5a, and 5b illustrate the first embodiment of the disclosure, wherein the extended portions (13, 23) of the first terminal 1 and the second terminal 2 are disposed within the extended grooves (3301, 3302) of the terminal receiving grooves (331, 332). And, the extended grooves (3301, 3302) of the rim 330 are disposed on opposite surfaces such that the extended portions (13, 23) of the first terminal 1 and the second terminal 2 are respectively disposed on the first surfaces 3303 and the second surfaces 3304, opposite to the first surfaces 3303. In the first embodiment of the disclosure, each contact portions 11 of the first terminal 1 protrudes from the extended grooves 3301 of the first surfaces 3303 of the rim 330 such that the contact portions 11 of the first terminal 1 becomes a flexible arms extended away from the tongue portion 31 of the insulator 3. The industrial standard of USB 3.0 requires that the contact portions 11 of the first terminal 1 and the contact portions 21 of the second terminal 2 should be disposed on nearby planes, and thus the end of the extended portions 23 of the second terminal 2 should be bend toward the contact portions 11 of the first terminal 1 such that each contact portions 21 of the second terminal 2 can be disposed on the plane that is approximated to that of the respective contact portions 11 of the first terminal 1.

In the first embodiment of the disclosure, the tail portions (12, 22) of the terminals (1, 2) are the through hole type (DIP type), however, another types of terminal suitable for the Surface Mount Technology (SMT) may be employed to implement the first embodiment of the disclosure. Therefore, any persons having ordinary skills in the related art can easily apply the first embodiment of the disclosure to the SMT terminal of the common electric connector, and thus the technique of the disclosure can be applied to variable terminal tail types is disclosed. Any person having ordinary skills in the related art would readily understand minor modification as described above and may practice such modified embodiment of this invention without undue experimentation.

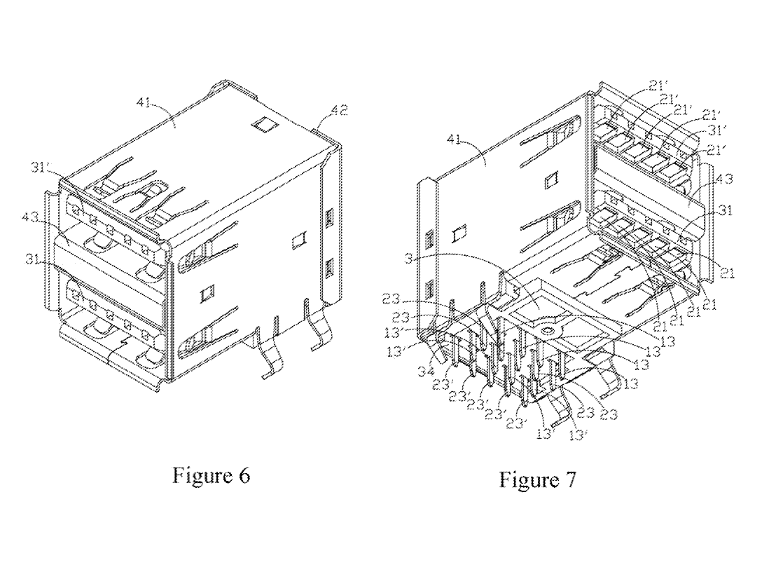

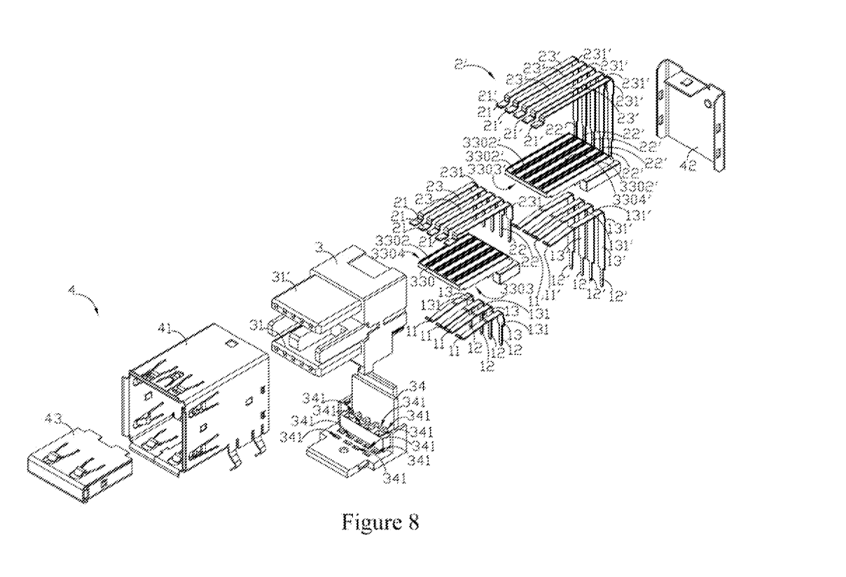

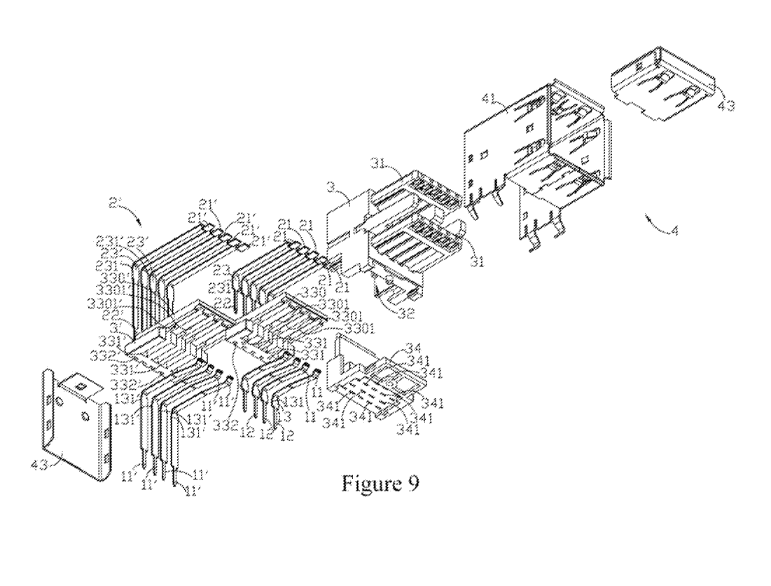

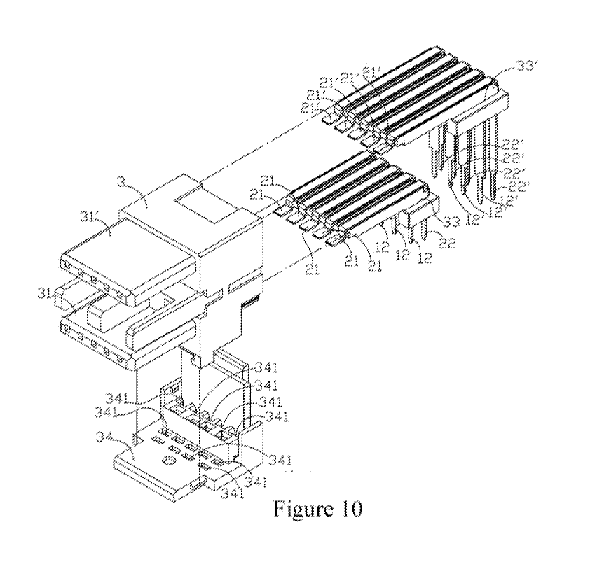

FIGS. 6-10 illustrate the second embodiment of the disclosure, wherein the Universal Serial Bus connector disposed on a print circuit board (not shown), is a Universal Serial Bus connector having duel ports stacked vertically on the print circuit board. It also can be understood as duel USB connectors stacked on the circuit board. The equivalent embodiment of the Universal Serial Bus connector encompasses three or four ports stacked thereon can be derived from the second embodiment of the disclosure.

The second embodiment of the disclosure is an equivalent of the first embodiment, and thus its main structure is substantially the same as that of the first embodiment except the Universal Serial Bus connector in the second embodiment has two stacked ports, which are vertically on the aforesaid print circuit board. Therefore, simply by stacking the design provided in the first embodiment would not achieve optimal performance, and thus this disclosure further provide the second embodiment to illustrate the preferred design that applies the disclosed technique on to the stacked Universal Serial Bus connector. The second embodiment of the disclosure comprises two sets of the first terminals (1, 1′), two sets of the second terminals (2, 2′), an insulator 3, and a shielding shell 4. Each of the first terminals (1, 1′) and the second terminals (2, 2′) respectively has a contact portion (11, 11′, 21, 21′), a tail portion (12, 12′, 22, 22′), and an extended portion (13, 13′, 23, 23′). The contact portions (11, 11′, 21, 21′) of the first terminals (1, 1′) and the second terminals (2, 2′) can be respectively connected to the dock connector or a complement USB electrical device (not shown). The tail portions (12, 12′, 22, 22′) of the first terminals (1, 1′) and the second terminals (2, 2′) can form an electric connection to a circuit board (not shown). The extended portions (13, 13′, 23, 23′) of the first terminals (1, 1′) and the second terminals (2, 2′) connect to the contact portions (11, 11′, 21, 21′) and the tail portions (12, 12′, 22, 22′) of the terminals (1, 1′, 2, 2′). The first terminals (1, 1′) and the second terminals (2, 2′) are respectively fixed on the insulator 3.

In the second embodiment, the insulator 3 is made of an insulating material and two tongue portions (31, 31′) respectively extended toward two dock connectors (not shown), and a notch 32 is formed on the insulator 3 away from the tongue portions (31, 31′). The notch 32 of the insulator 3 can accommodate at least one upper cap 33 and at least one lower cap 33′, which are respectively assembled into the insulator 3. The two caps (33, 33′) of the insulator are removably disposed on the insulator 3. The extended portions (13, 13′, 23, 23′) of the first terminals (1, 1′) and the second terminals (2, 2′) are respectively disposed on the caps (33, 33′), and the caps (33, 33′) of the insulator 3 have the first terminal receiving groove (331, 331′) and the second terminal receiving grooves (332, 332′) to accommodate a portion of the extended portions (13, 13′, 23, 23′) of the first terminals (1, 1′) and the second to terminals (2, 2′). The first terminals (1, 1′) and the second terminals (2, 2′) are disposed on the insulator 3 by disposing the first terminals (1, 1′) and the second terminals 2, 2′ on the terminal receiving grooves (331, 331′, 332, 332′) of the caps (33, 33′), which are subsequently disposing the caps (33, 33′) on the insulator 3.

In the second embodiment, the shielding shell 4 comprises a body 41, a rear cover 41, and a separating panel 43. The body 41 of the shielding shell 4 encloses the insulator 3. The separating panel 43 of the shielding shell 4 is disposed between the upper cap 33 and the lower cap 33′ of the insulator 3, and the rear cover 42 of the shielding shell 4 is disposed on a surface remote from the matched mechanism for the dock connector (not shown).

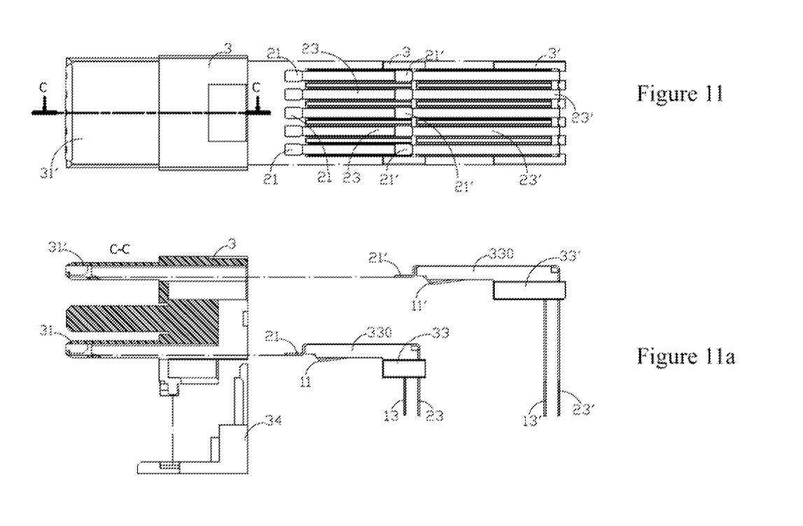

FIGS. 11 and 11a illustrate the second embodiment of the disclosure, wherein the insulator 3 optionally comprises the spacer 34, which includes a plurality of perforating channels 341 along the direction of the circuit board. The perforating channels 341 of the spacer 34 are provided so that he tail portions (12, 12′, 22, 22′) of the terminals (1, 1′, 2, 2′) may penetrate there through, and ensure that the tail portions (12, 12′, 22, 22′) of the terminals (1, 1′, 2, 2′) would not contact each other accidentally. The spacer 34 in the second embodiment can be disposed within the notch 32 of the insulator 3 and between the caps (33, 33′) and the rear cover 42 of the shielding shell 4. The rear cover 42 of the shielding shell 4 and the spacer 34 of the insulator 3 provide adequate retention forces for caps (33, 33′) to prevent the caps (33, 33′) from disengaging from the notch 32 of the insulator 3.

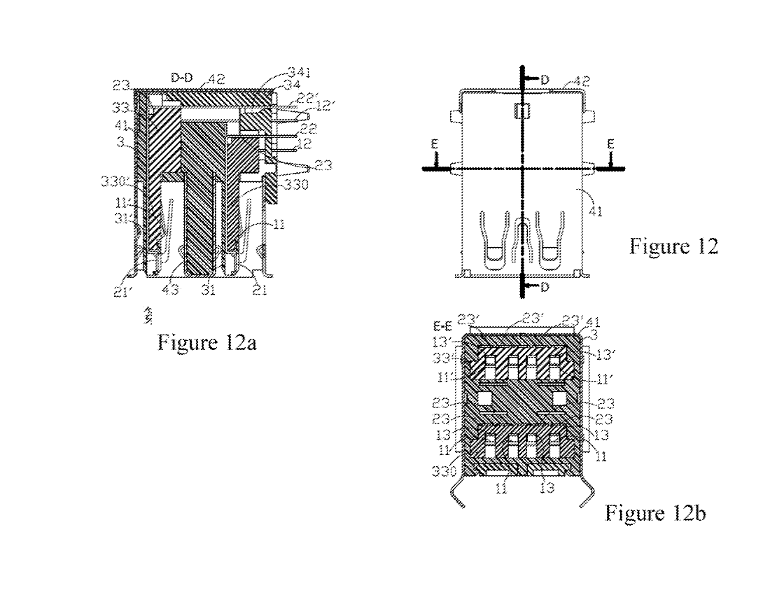

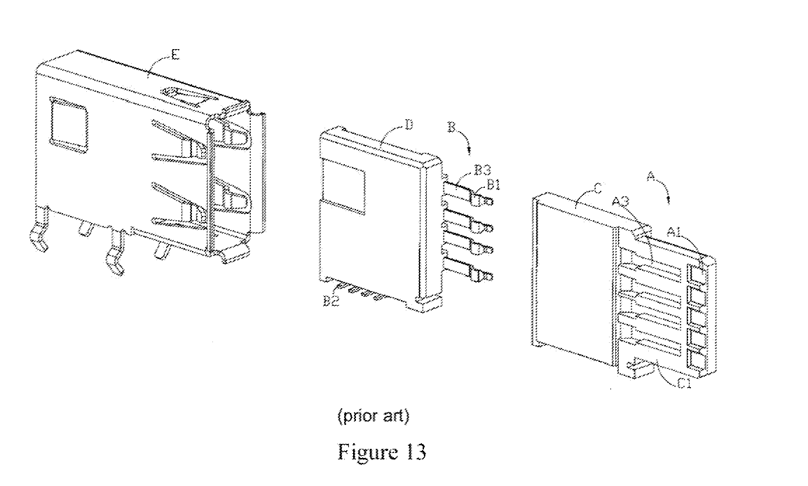

FIGS. 12, 12a and 12b illustrate that rims (330, 330′) are respectively extended from two caps (33, 33′) of the insulator 3, and extended grooves (3301, 3301′, 3302, 3302′) are respectively disposed along the first surfaces (3303, 3303′) and their respective opposite surfaces (3304, 3304′) of the rims (330, 330′). At least a portion of each of the extended portions (13, 13′, 23, 23′) of the first terminals (1, 1′) and the second terminals (2, 2′) is accommodated within the extended grooves (3301, 3301′, 3302, 3302′). When the contact portions (11, 11′, 21, 21′) of the terminals (1, 1′, 2, 2′) are not engaged, the contact portions (11, 11′, 21, 21′) of the terminals (1, 1′, 2, 2′) are arranged in different planes that are away from the tongue portions (31, 31′) of the insulator 3, following the USB industrial standard. The separating panel 43 of the shielding shell 4 separates the insulator 3 into upper and lower portions so that the dock connector may respectively contact the terminals (1, 1′, 2, 2′) of the caps (33, 33′).

Although the disclosure has been described in considerable detail with reference t certain preferred embodiments thereof, it will be apparent to those skilled in the art that various modifications and variations can be made to the structure of the disclosure without departing from the scope or spirit of the disclosure. Therefore, it is intended that the disclosure cover modifications and variations of this disclosure provided they fall within the scope of the following claims and their equivalents.

What is claimed is:

1. An improved Universal Serial Bus (USB) connector mounted on a print circuit board for transmitting electric signals between a dock connector and the print circuit board, wherein the improved Universal Serial Bus connector comprises a set of first terminals, a set of second terminals, an insulator, and a shielding shell, wherein
each of the first terminals and the second terminals respectively includes a contact portion, a tail portion, and an extended portion,
the contact portion of each of the first terminals and the second terminals is respectively connected to the dock connector,
the tail portion of each of the first terminals and the second terminals is respectively electrically connected to the dock connector,
the extended portion of each of the first terminals and the second terminals is electrically connected to the contact portion and the tail portion of each of the terminals,
each of the first terminals and the second terminals is respectively fixed on to the insulator, and the shielding shell substantially encloses the insulator,
wherein the improvement comprises:
a cap removably disposed on the insulator and having a plurality of terminal receiving grooves disposed thereon for receiving a portion of the extended portion of each of the first terminals and the second terminals, and thereby allowing the contact portion of each of the first terminals protruding out of terminal receiving grooves of the insulator, and each of the first terminals and the second terminals is fixed on the insulator by the cap.

2. The improved Universal Serial Bus connector of claim 1, wherein the cap includes a rim, and the extended portion of each of the first terminals is respectively disposed on a first surface of the cap proximate to the print circuit board.

3. The improved Universal Serial Bus connector of claim 1, wherein the insulator includes a spacer, which includes a plurality of perforating channels, each of the plurality of perforating channels respectively secure a tail portion of a terminal to prevent the tail portions of the terminals from accidentally contacting each other.

4. The improved Universal Serial Bus connector of claim 2, wherein the extended portion of each of the second terminals is bended such that the contact portion of each of the second terminals is disposed on the plane proximate to the first surface of the cap.

5. The improved Universal Serial Bus connector of claim 1, wherein the insulator includes a tongue portion, which extends away from the tail portion of each of the first terminals and the second terminals, and the cap is disposed close to a surface of the tongue portion of the insulator.

6. The improved Universal Serial Bus connector of claim 1, wherein the insulator includes a notch, which contains at least the cap such that the cap is disposed within the insulator.

7. An improved Universal Serial Bus (USB) connector mounted on a print circuit board for matching two dock connectors simultaneously, wherein the improved Universal Serial Bus connector comprises two sets of first terminals, two sets of second terminals, an insulator, and a shielding shell, wherein
each of the first terminals and the second terminals respectively includes a contact portion, a tail portion, and an extended portion,
the contact portion of each of the first terminals and the second terminals is respectively connected to the dock connector,
the tail portion of each of the first terminals and the second terminals is respectively electrically connected to the dock connector,
the extended portion of each of the first terminals and the second terminals is connected to the contact portion and the tail portion of each of the terminals,
each of the first terminals and the second terminals is respectively fixed on the insulator, and the shielding shell substantially encloses the insulator,
wherein the improvement comprises:
two caps disposed within the insulator, and stacked along a direction vertical to the circuit board,
wherein each caps of the insulator is removably disposed in the insulator and comprises a plurality of terminal receiving grooves disposed thereon for receiving portions of the extended portion of each of the first terminals and the second terminals,
wherein the contact portion of each of the first terminal is protruded from the terminal receiving groove of the insulator, and the extended portion of each of the first terminals and the second terminals is respectively disposed in a suitable terminal receiving groove of the cap used for fixing each of the first terminals and the second terminals on the insulator.

8. The improved Universal Serial Bus connector of claim 7, wherein the two caps are molded into one unit, and each of the first terminals and the second terminals is respectively disposed on the two caps that are molded into one unit.

9. The improved Universal Serial Bus connector of claim 7, wherein the insulator includes a separator, which includes a plurality of perforating channels, each of the plurality of perforating channels respectively fixes the tail portions of each terminals to prevent the tail portions of each terminals from accidentally contacting each other.
